(19) United States
(12) Patent Application Publication
(10) Pub. No.: US 2013/0061426 A1
(43) Pub. Date: Mar. 14, 2013

(54) SHIELD FOR COOKING UTENSIL

(71) Applicant: Itai Achiaz, New York, NY (US)

(72) Inventor: Itai Achiaz, New York, NY (US)

(21) Appl. No.: 13/586,379

(22) Filed: Aug. 15, 2012

Related U.S. Application Data
(60) Provisional application No. 61/523,754, filed on Aug. 15, 2011.

(51) Int. Cl. A47J 43/28

(52) U.S. Cl. CPC A47J 43/28
USPC 16/110.1

(57) ABSTRACT

A shield is provided for a utensil that includes a handle and includes a shield body having a first opening formed therein. The first opening is open along a perimeter edge of the shield body. The shield includes a locking mechanism attached to a first face of the body and disposed about the first opening and being configured to grasp and hold the handle, thereby attaching the shield to the utensil.

### CROSS-REFERENCE TO RELATED APPLICATIONS

The present application claims priority to and the benefit of U.S. Patent Application No. 61/523,754, filed Aug. 15, 2011 which is hereby incorporated by reference in its entirety.

### TECHNICAL FIELD

The present invention relates to implements for cooking utensils, and in particular, to a shield member for use with a cooking utensil to protect a user from a splatter, heat and the like during the stirring or manipulating of foods during cooking.

### BACKGROUND

Cooking exposes an individual to a number of potentially dangerous situations due to the presence of sharp implements and due to the presence of heat and foods that are at elevated temperatures, etc. For example, in the use of cooking implements during the cooking process, a person's hands and arm are exposed to a number of potentially dangerous conditions, including hot splatters (e.g., grease splatter or hot liquid splatter, etc.) and heat from the cooking surface, from the heated food, etc.

While various protective screens and other devices have been proposed, there are deficiencies with each of these.

### SUMMARY

In one embodiment, a shield is provided for a utensil that includes a handle. The shield includes a shield body having a first opening formed therein. The first opening is open along a perimeter edge of the shield body. The shield includes a locking mechanism attached to a first face of the body and disposed about the first opening and being configured to grasp and hold the handle, thereby attaching the shield to the utensil.

The locking mechanism includes a clamp body that has a first section that is attached to the first face of the body and a pair of flexible fingers extending outwardly from the first section. Each finger terminates in a coupling member that has first and second protrusions extending radially outward therefrom. The locking mechanism further includes a pair of rotatable clamp arms that are rotatably coupled to the coupling members of the flexible fingers such that the clamps arms are in adjacent, parallel planes and are movable between an open position and a closed position. Each clamp arm has an opening that receives a portion of the respective coupling member and a V-shaped body section. The clamp arm includes a catch member that is configured to fasteningly mate with the first protrusion, thereby locking the clamp arm to the coupling member resulting in the clamp arms being locked in the closed position.

The clamp arms are at least partially overlapped and in the open position, the clamp arms define a V-shaped slot for receiving the handle and in response to movement of the handle in a direction toward the first opening. The clamp arms rotate about the coupling members until the clamp arms assume the closed position in which the handle is captured between the V-shaped bodies of the clamp arms and the first protrusion is fasteningly mated with the catch member, thereby securely attaching the shield to the handle.

### BRIEF DESCRIPTION OF THE DRAWINGS

FIG. 1-10 show various view of shields according to different embodiments for use with a cooking utensil, such as a spatula;

FIG. 11 is front and top perspective view of a shield mechanism according to another embodiment and showing the mechanism in a first open position;

FIG. 12 is an enlarged perspective view of a locking members of the shield mechanism of FIG. 11;

FIG. 13 is a top perspective view of the shield mechanism of FIG. 11 in a second locked position;

FIG. 14 is a top plan view of the shield mechanism in the second locked position;

FIG. 15 is an enlarged perspective view of a lock member of the locking members of the shield mechanism of FIG. 11; and

FIG. 16 is a side elevation view of the shield mechanism in the second locked position.

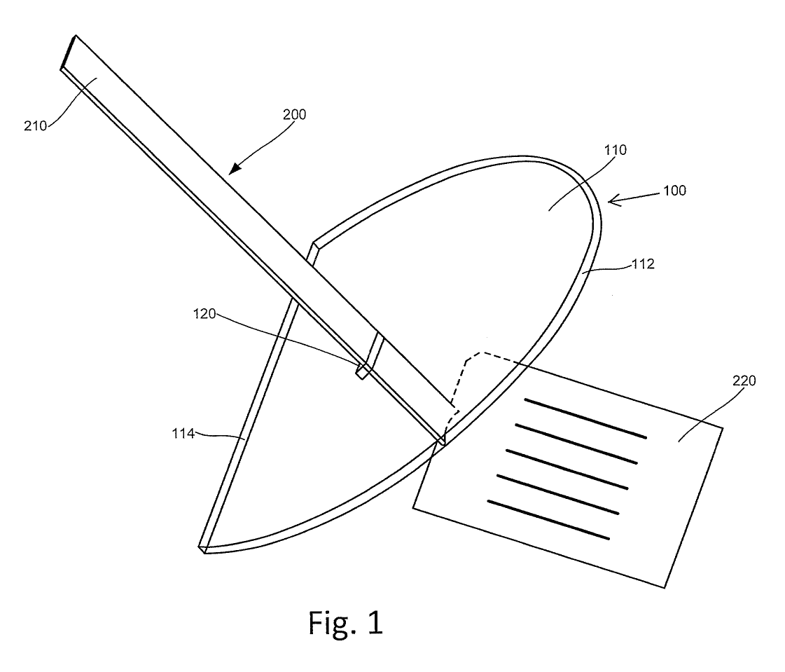

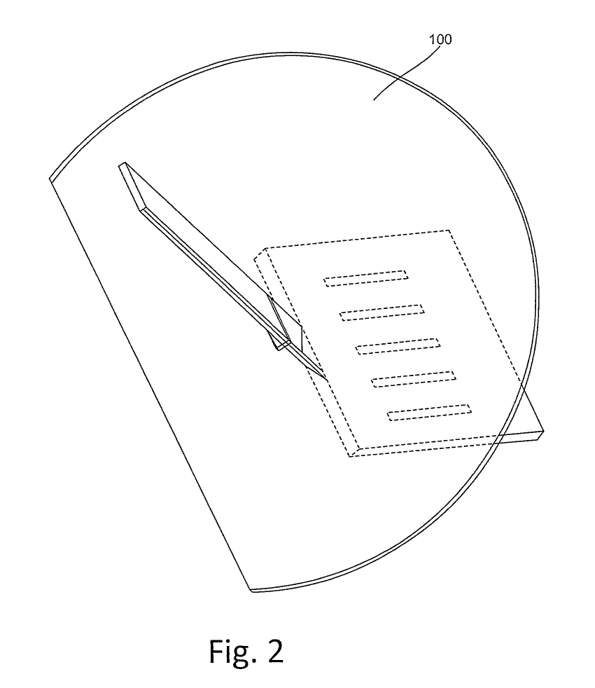

### DETAILED DESCRIPTION OF CERTAIN EMBODIMENTS OF THE INVENTION

In accordance with a first embodiment of the present invention, a shield 100 for use with a cooking utensil 200 is shown.

The cooking utensil 200 has an elongated handle 210. In the illustrated embodiment, the utensil 200 is an angled spatula that includes handle 210 and a “blade portion” 220.

It will be appreciated that the cooking utensil 200 can be any number of different types of utensils, such as a cooking fork, spoon, spatula, etc. In other words, the cooking utensil 200 can be any number of different cooking utensils that have an elongated handle.

The shield 100 is designed to be disposed along the handle 210 and in particular, be fixedly attached to the handle 210 at an intermediate location. The shield 100 can be formed of any number of different materials including different types of plastics and even metals. Since the shield 100 will be proximate cooking areas that have elevated temperatures and may come into contact with liquids or solids that have elevated temperatures, the shield 100 should be formed of a material that can withstand such temperatures. For example, certain plastics and rubbers are suitable for such uses and in fact, plastics and rubbers that are used to make the utensils 200 themselves can be used to form the shield 100.

The shield 100 is shaped and sized so as to provide a shield that protects the hand of the person who is grasping the handle 210 to which the shield 100 is attached. Thus, the width of the shield should be such that an adult hand is effectively shielded from potential splatter and from the elevated temperatures of a cooking pan, stove, food, etc. The illustrated shield 100 is made up of a body 110 that has an arcuate front edge 112 and a planar rear edge 114. In other words, the front edge 112 of the body 112 is curved, while the rear edge 114 is flat. The flat rear edge 114 serves a purpose in that it allows the assembled shield 100 and utensil 200 to sit on a planar ground surface, such as a kitchen counter. When assembled, the shield 110 is generally perpendicular to the handle 210 and therefore, when the blade member 220 is placed on the ground and the shield 110 can be positioned with the flat rear edge 114 in contact with the ground and thus provides a vertical support member that allows the blade member 220 of the utensil 200 to be free of contact with the ground surface. Thus, the shield 100 is designed to permit the hot and/or dirty blade member 220 from being in contact with a kitchen countertop.

An opening or slot 120 is formed within the body 110 to allow reception of the handle 210. The opening 120 is thus sized and shaped to receive the handle 210.

A means is provided for limiting the degree of travel of the shield 100 along the handle 210 and in particular, the shield 100, in the final assembled position, is spaced from the blade member 220. Any number of different means can be used to lock the shield in place along the handle 210 at a desired location. For example, the handle 210 can be formed to include at least one stop member formed along the handle 210 such that when the shield 100 slides down the handle 210 from the free end toward the blade member 220, travel of the shield 100 is limited by the stop member, such as a protrusion or lip formed as part of the handle 210. The shield 100 seats against the stop member and is prevented from traveling further toward the blade member 220 and is held in place at an intermediate location along the handle 210.

Alternatively, the handle 210 can be formed to have a non uniform width and the opening 120 is formed so that travel of the shield 100 down the handle 210 is limited by the wider section of the handle 210. Thus, when the shield 100 encounters the wider section of the handle 210, its travel toward the blade member 220 ends and it is fixed in an intermediate location along the handle 210.

Alternatively, the means can be associated with the shield 100. For example, the shield 100 can include a mechanism that causes the shield 100 to be locked in place at an intermediate location.

A mechanical fit, such as a releasable snap fit, can be formed between the shield 100 and the handle 210 in that within the opening 120 of the shield 110 one or more biased member, such as a nub or protrusion, can be provided and once the biased member is in registration with a recessed portion formed along the handle 210, the member is biased into the recessed portion, thereby securing the shield 110 to the handle 210. To release the shield 100, the user simply overcomes the biasing force by pulling the shield 100 in a direction away from the blade member 220, thereby disengaging the member from the recess.

In addition, the shield can have a fastening element associated therewith that allows the shield 100 to be attached to the handle 210 of the utensil 200. For example, proximate the opening formed in the shield, the shield 100 can include a flexible tab that has a first fastener that mates with a second fastener that is part of the handle 120. Fasteners can be in the form of a button or rotatable screw, etc.

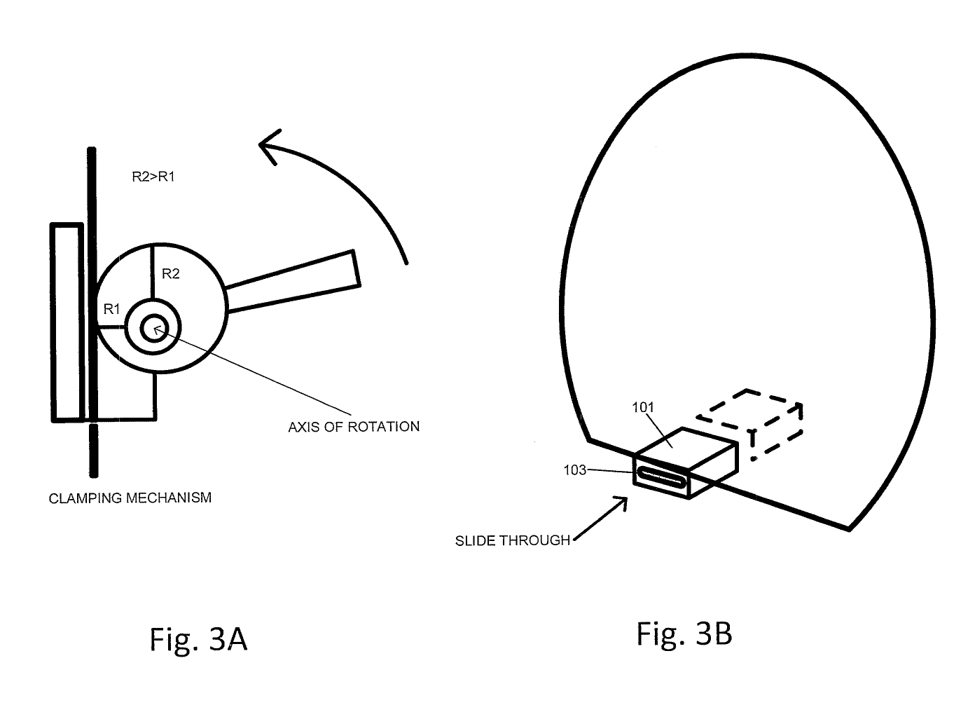

In addition, the shield 100 can have a clamping mechanism that upon actuation has a portion that travels into the opening formed in the shield 100 and into contact with the handle 120. For example, a pivotable lever or handle can be part of the clamping mechanism such that when pivoted a claw or protrusion applies a force against the handle 120 so as to securely hold the handle 120 in place within the opening of the shield 100. FIG. 3A shows one type of clamping mechanism that is formed of an eccentric member that pivots about a pivot point but is defined by multiple radii. Thus, as the eccentric member is rotated and the larger radii (r2) portion comes into contact with the handle 210, it will effectively pinch and hold the handle 210 within the shield opening. To move or release the shield 100 from the handle 210, the lever is rotated.

In addition and as shown in FIG. 3B, the shield 100 can include an inner sleeve 101 that can be manipulated to cause a secure fit between the shield 100 and the handle 210 by passing the handle 210 through a through slot 103 formed in the sleeve 101. For example, the sleeve can be tightened over the handle 210 to cause the shield 100 to remain fixed in place at a desired intermediate location along the length of the handle 210.

The shield 100 should be positioned at an intermediate location just below the normal gripping location of the hand.

In yet another embodiment, the shield 100 is integral to the handle 210 and is of a type that moves between a retracted position and an extended or deployed position. In this design, there is a bottom pivot point that permits the shield 100 to pivot into a generally perpendicular position relative to the handle 210. The shield 100 can therefore be designed to first unfold and then pivot about the bottom pivot into the deployed position in which the shield 100 is generally perpendicular to the handle 210.

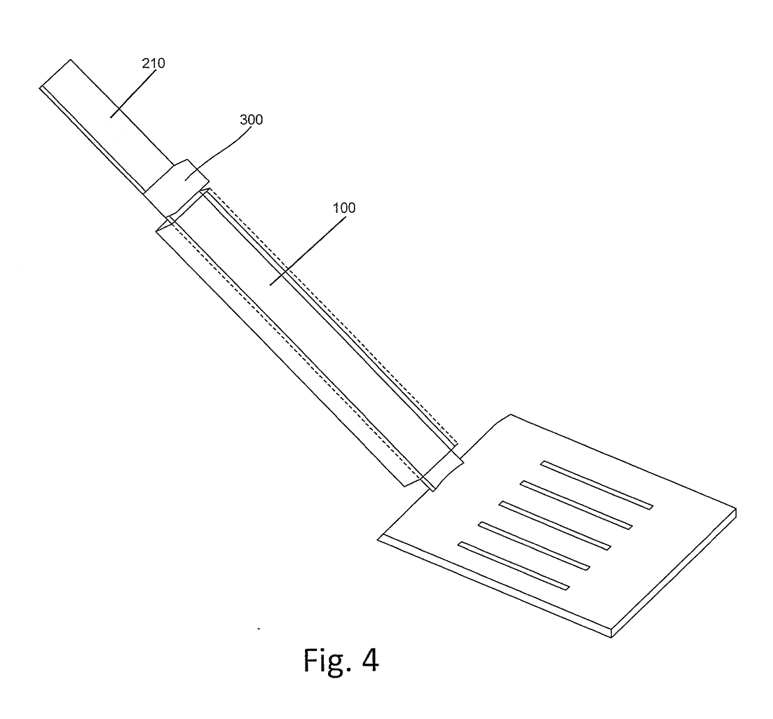

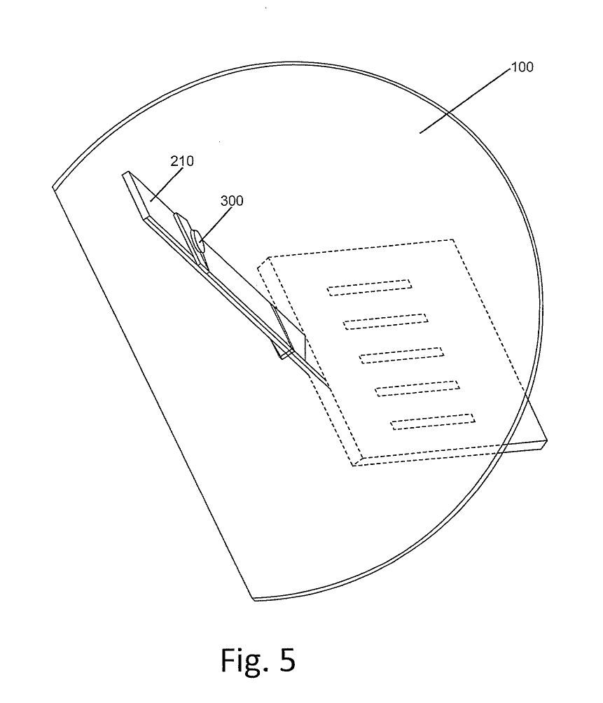

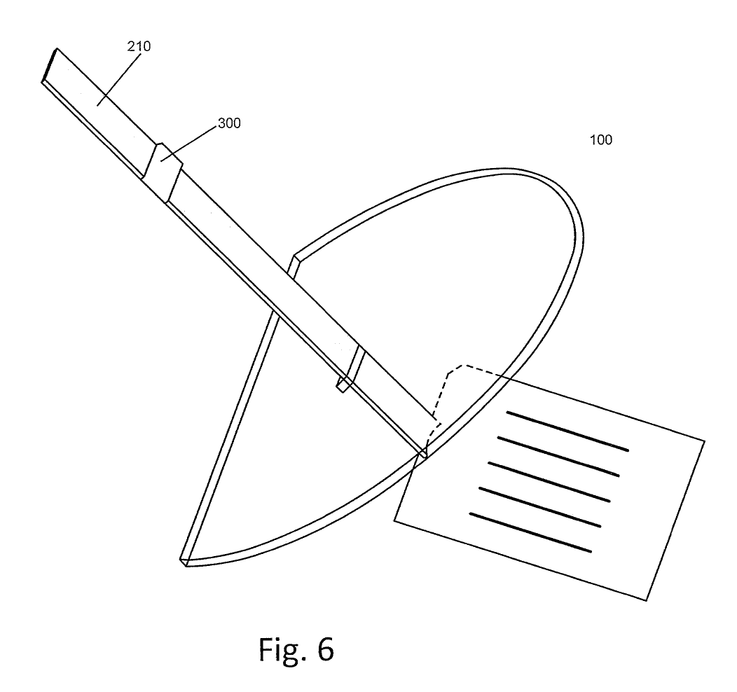

Any number of different means (mechanisms) can be used to cause the deployment and allow the retraction of the shield 100. For example, the shield 100 can be of a foldable type (like a fan) that is coupled to a biasing member (such as a spring) that causes the automatic deployment of the shield 100. In FIG. 4, an actuator 300 in the form of a button is shown for actuating the deployment mechanism. For example, upon pressing the button, an internal locking member is caused to move and permit the biasing element (spring) to release its energy and thereby cause the deployment of the shield 100.

Alternatively, the shield 100 can be manually deployed as with an oriental paper fan. A clip or other type of locking mechanism is provided to allow the shield 100 to be contained in the locked position (deployed position). Once the clip or lock is disengaged, the side edges of the shield 100 are pulled radially outward so as to increase the exposed surface area of the shield 100 (increase its size). The shield 100 in this embodiment has a bottom pivot that permits the shield 100 to pivot into a position that is generally perpendicular to the handle 210. Thus, the outer edge of the shield 100 can include a locking member to lock to the handle 210 and in particular, a clip or the like can be used to attach the shield 100 to the handle 210. The bottom pivot can be in the form of a pin of the like that passes through a structure (such as a boss) that is part of the shield 100.

In addition, the shield can be formed of a material that has memory properties, such as Nitinol, or of the similar materials. In this design, once a catch or lock is disengaged from the shield, the shield will move to its normal rest position which represents the deployed position.

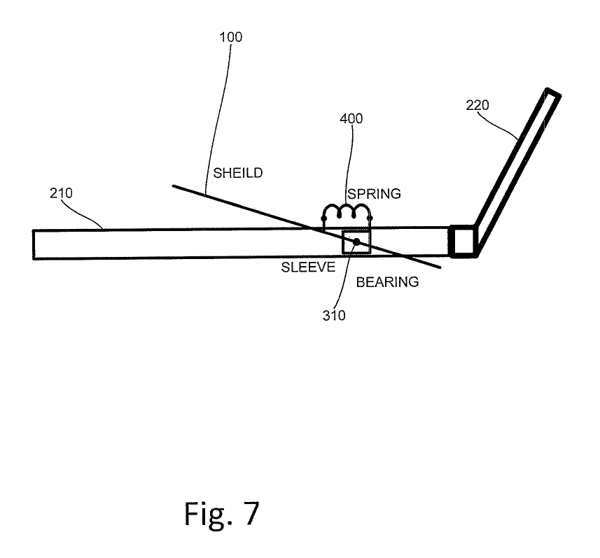

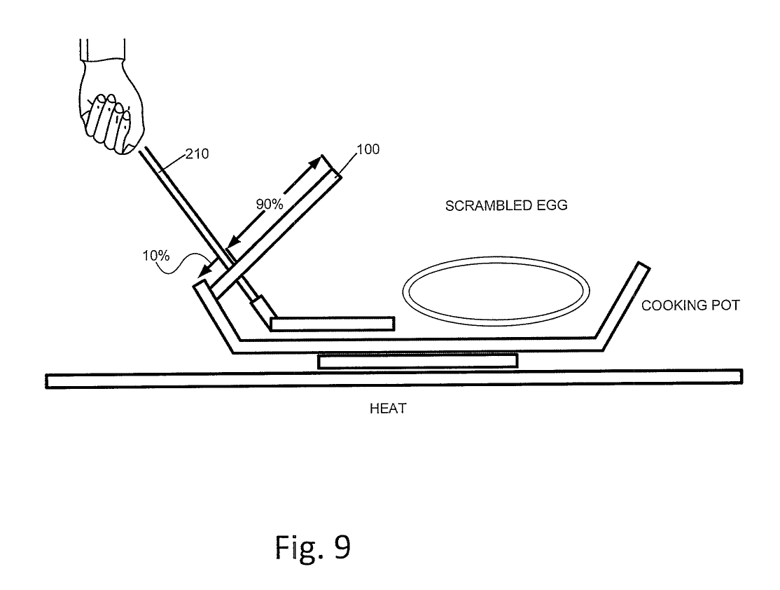

FIGS. 7-10 show a similar pivoting design in which the shield 100 is attached to the handle 210 by means of a pivot 310 such as a pivot pin. The shield 100 is constructed such that in a retracted position, a first section of the shield 100 is located on one side of the handle 210, while a second larger section of the shield 100 is located on the other side of the handle 210. In one embodiment shown in FIG. 9, the first section represents about 10% of the width (bottom) and the second section represents about 90% of the width (upper) at a location of the shield that is disposed over the handle 210.

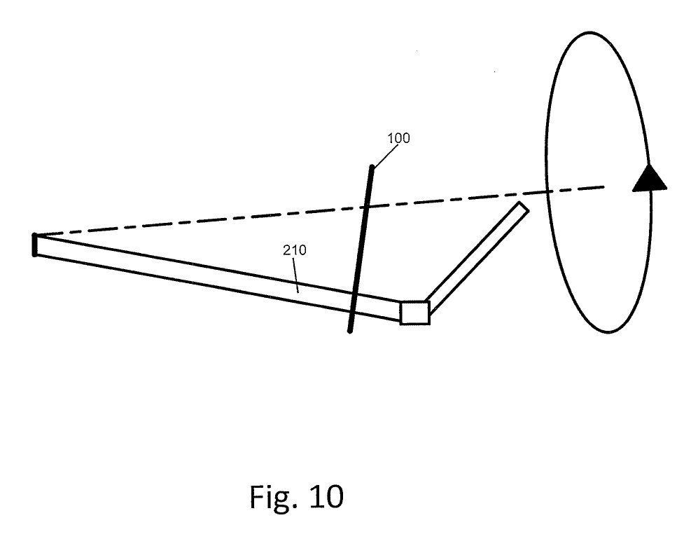

As will be appreciated from FIG. 9, if the lower part were of the same radius as the upper part, the spatula shield would get stuck relative to the cooking pot walls when the user wants to place the spatula under the scrambled egg. This is the reason why the lower part can be formed to have a much shorter length. At the same time, no sacrifice has been made in terms of the protection. As is presented, the shield with the cooking pot boundaries provides the user have full body protection. Also, in FIG. 10, the shield (matter) distribution is more effective to integrate with the natural food-flipping motion.

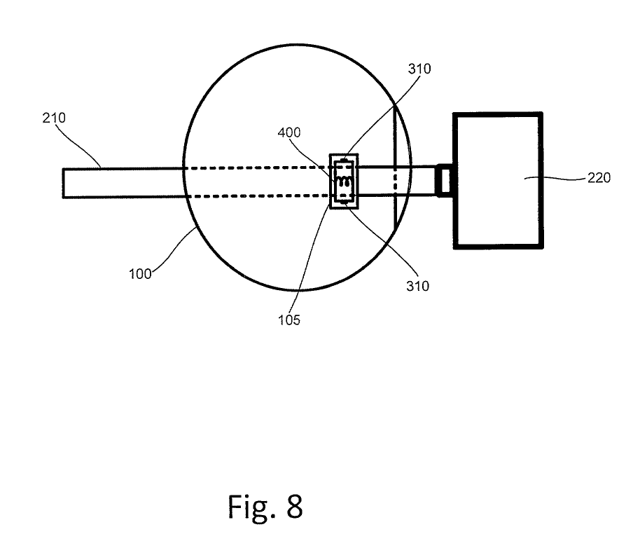

FIG. 8 shows a top view and it will be appreciated that the shield 100 includes a central opening 105 formed near the flat edge of the shield 100. The opening 105 is sized and shaped to receive the handle 210 and permit the shield 100 to pivot relative to the handle 210. Within the opening 105, a pair of pins 310 are positioned with one end being fixedly attached to the shield 100 and the other end being rotatably coupled to the handle 210 (e.g., through use of bearings, etc.).

A biasing member 400, such as a spring, can be biasedly attached to the shield 100 and the handle 210 such that when the biasing member 400 applies its biasing force, the shield 100 moves into the deployed position and can be moved to a position in which the shield 100 is generally perpendicular to the handle 210.

In this embodiment, the shield still includes a flat rear edge, etc.

It will therefore be appreciated that the shield of the present invention is both in the form of a shield 100 that is separate from the utensil and is attached thereto or it can be part of the handle and it pivots into a deployed position.

The shield 100 can be formed of any number of different materials, such as a plastic or rubber that can endure heat. The shield 100 can be formed of a transparent material to allow the food, etc., to be visible therethrough and therefore, the shield 100 does not interfere with use of the utensil.

The following objects are achieved with the shield of the present invention: attachable/removable shield; integral shield that has a fold position; attachable/removable shield that also have fold position; and the shield protects not only the hand of the user but also protect the rest of the body (FIG. 9).

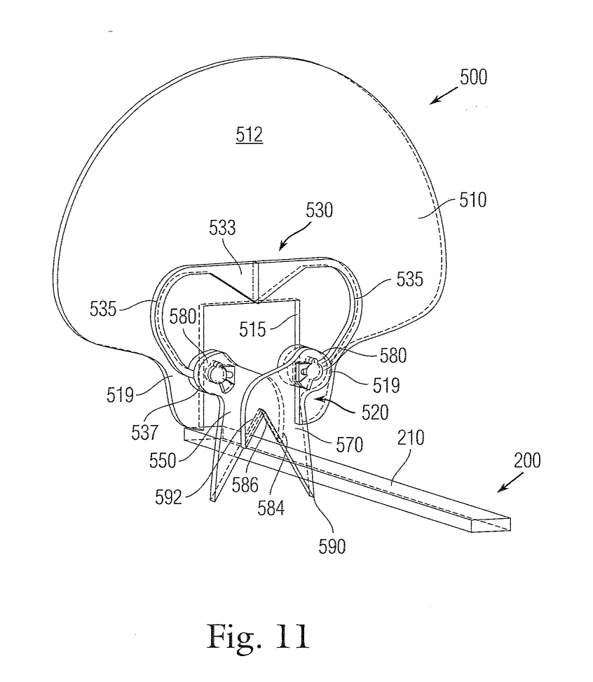

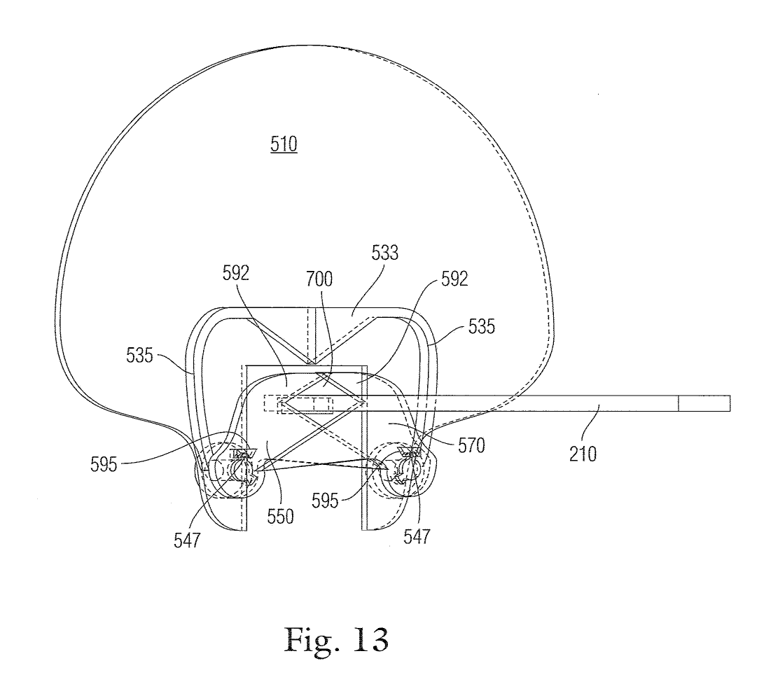

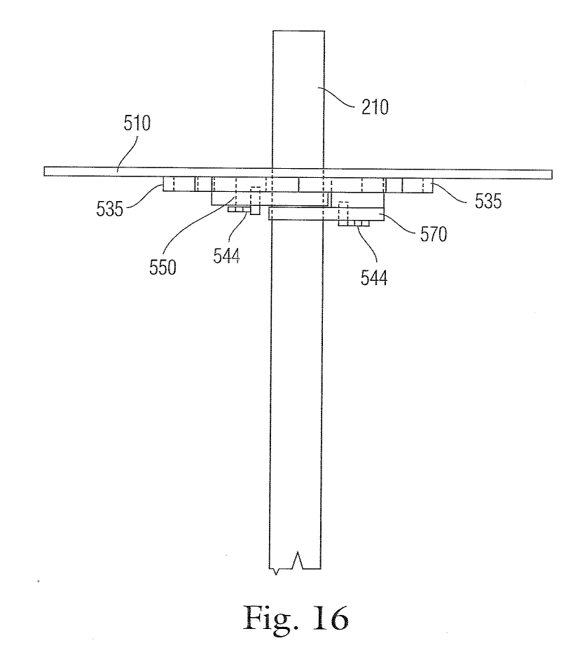

FIGS. 11-16 illustrate a shield 500 for use with the cooking utensil 200 which can take a form previously described herein. The utensil 200 has an elongated handle 210.

The shield 500 includes a base or shield body 510 that is similar to the shield bodies described herein and is intended to shield the user from hazards while using the utensil 200 to which the shield 500 is attached. The shield 500 can take any number of different shapes and materials so long as the shield 500 performs the intended function of acting as a shield and withstanding heat, etc. The shield body 510 has a surface 512 that can be a rear surface that faces downward towards the working part (not shown) of the utensil 200 and the source of heat, etc.

The shield body 510 includes a cutout/opening 515 formed therein and open along a perimeter edge 511 of the body 510. In the illustrated embodiment, the cutout 515 has a square or rectangular shape.

The shield 500 includes a locking mechanism 520 for securely grasping the handle 410 to thereby attach the shield 500 to the utensil 200 (i.e., handle 210 thereof). The locking mechanism 520 includes a clamp base portion 530 that attaches to the surface 512 and a pair of pivotable clamp arms 550, 570. As illustrated, the clamp base portion 530 is constructed so as to extend around the shield opening 515 and not interfere therewith. The illustrated clamp base portion 530 includes a central section 533 which can be the main attachment point between the locking mechanism 520 and the body 510 and a pair of arcuate shaped rails or fingers 535 that extend outwardly from the central section 533 and terminate at distal ends 537. The fingers 535 are formed of a resilient material (such as plastic) and therefore can flex and open or close relative to one another depending upon the applied force.

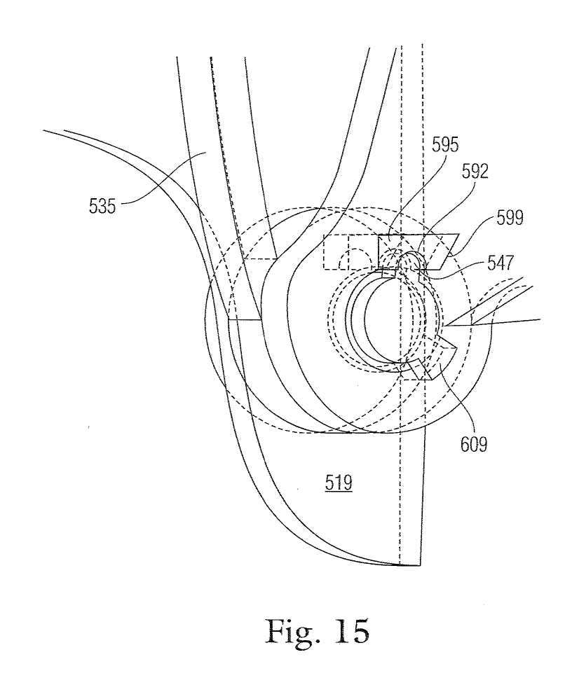

At the distal ends 537, there are coupling members 540 in the form of bosses that extend outwardly therefrom. In the illustrated embodiment, the coupling members 540 can be in the form of circular shaped bosses that has a first section 542 defined by a first diameter and a second section 544 defined by a second diameter less than the first diameter so as to form an annular shaped landing 545. The coupling members 540 seat against extensions 519 of the shield body 510 that define, in part, the opening 515, as best shown in FIG. 15. However, the coupling members 540 are preferably not directly attached to these extensions 519. The coupling member 540 and in particular, the second section 544 thereof includes a locking protrusion (nub) 547 that extends outwardly therefrom. The locking protrusion 547 can have a rounded shape.

The pivotable clamp arms 550, 570 of the locking mechanism 550 are pivotally attached to the coupling members 540 and in particular are disposed such that they seat against the landing 545. Each clamp arm 550, 570 includes has a first section (e.g., circular in shape) 580 that includes an opening 582 that is complementary in shape to the shape of the second section 544 of the coupling member 540. The arm 550, 570 has a second section 584 that is continuous with first section 582 and is generally V-shaped in that there is a V-shaped notch 586 defined therein. The V-shaped notch 586 is defined by a long pointed portion 590 and a short pointed portion 592 that are formed at an angle relative to one another.

Each of the clamp arms 550, 570 includes a catch member 595 that is complementary to the locking protrusion 547 such that when the catch member 595 receives the locking protrusion 547, the clamp arm 550, 570 is releasably locked in place. The catch member 595 is in the form of a raised structure that includes an opening or slot 592 that intimately receives and mates with the locking protrusion 547. The illustrated catch member 595 is generally C-shaped and is formed proximate to the opening 582. The catch member 595 also includes a beveled side edge 599 that limits the rotation of the clamp arm 550, 570 as described herein.

As shown, the clamp arms 550, 570 at least partially overlap with one another in that the height of one coupling member 540 is less than the other coupling member 540 so as to position the clamp arms 550, 570 in different parallel planes (adjacent parallel planes).

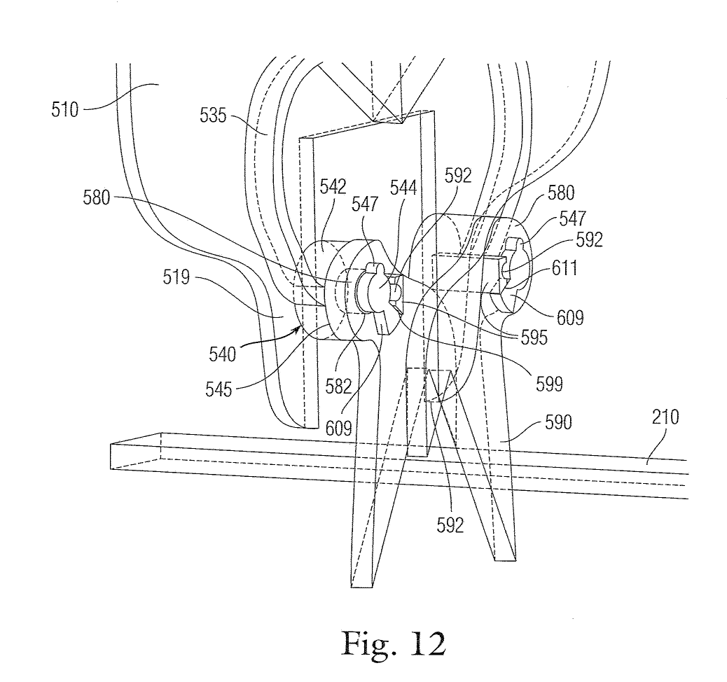

FIGS. 11 and 12 show the locking mechanism 520 in a first (open/unlocked) position to allow receipt of the handle 210. At this point, the shield 500 is not attached to the utensil 200. The short pointed portion 592 of the arm 570 is disposed over a section of the long pointed portion 590 of the arm 550 and the short pointed portion 592 of the arm 550 is disposed under a section of the long pointed portion 590 of the arm 570. This arrangement of the arms 550, 570 defines a V-shaped receiving space 600 into which the handle 210 is introduced.

As the handle 210 is advanced into the space 600, the handle 210 contacts the arms 550, 570 (i.e., the overlapped short and long pointed sections 590, 592) and continued movement of the handle 210 into the space 600 and toward the opening 515 of the body 510 causes the clamp arms 550, 570 pivot in the directions indicated by the arrows in FIG. 11 and in particular, the clamp arm 570 pivots in one direction (clockwise), while the clamp arm 550 pivots in the other direction (counterclockwise). In addition, the fingers 535 flex outwardly as shown by arrows in FIG. 11 due to their resiliency and the construction of the clamp (in effect the clamp body is opening as the fingers 535 flex outwardly and based on the fact that the fingers 535 are not attached to the shield body 510).

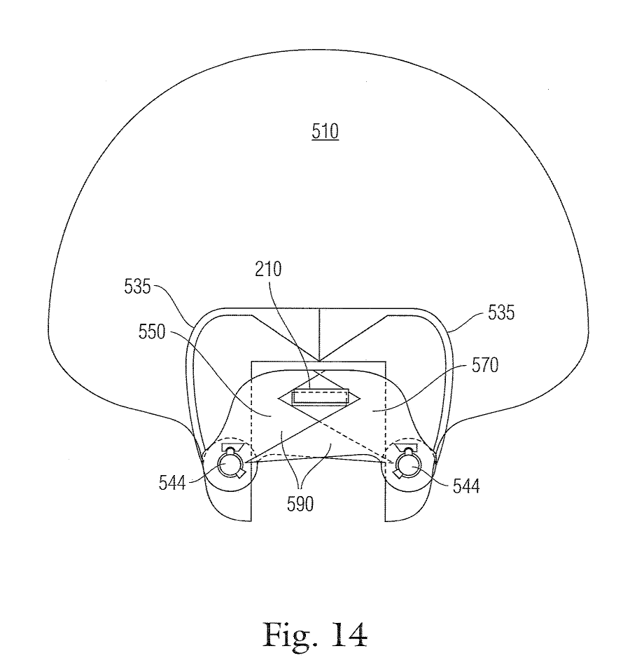

As the handle 210 is continually advanced, the clamp arms 550, 570 pivot and the fingers 535 open outwardly. The clamp arms 550, 570 then assume the locked position shown in FIGS. 14 and 15, whereby the handle 210 is captured within a completely or substantially bounded area 700 defined by the clamp arms 550, 570 and in particular, the area 700 can be generally diamond shaped and defined by the short pointed portions 592 and the long pointed portions 590 of arms 550, 570. In this position, the handle 210 is located deeper within the opening 515.

The locked position of the clamp arms 550, 570 is also achieved when the locking protrusions 547 are captured within the catch members 595 (see FIG. 15). Once this occurs, the clamp arms 550, 570 have reached their end of travel and can no longer pivot. The receipt of the protrusions 547 into the catch members 590 can be of a frictional nature and can thus be of releasable snap-fit nature in that as the clamp arm 550, 570 pivots the latch member 595 is brought into engagement with the protrusion 547 and can flex to accommodate receipt of the protrusion 547 to thereby form a snap-fit. The clamp arms 550, 570 are formed of solids (e.g., plastics) that have a low friction coefficient.

As shown in the figures, the rotation of the arms 550, 570 is also limited by a second protrusion 609 that extends outwardly from the second section 544 and is spaced from the protrusion 547. The protrusion 609 has a beveled edge 611 that engages the beveled side edge 599 of the catch member 595, thereby preventing further rotation of the clamp arm 550, 570 in said direction. The edges 599, 611 abut in the open position of FIGS. 11 and 12.

The handle 210 can be released by disengaging the clamp arms 550, 570.

The clamp body is preferably formed of a ductile material.

While the invention has been described in connection with certain embodiments thereof, the invention is capable of being practiced in other forms and using other materials and structures. Accordingly, the invention is defined by the recitations in the claims appended hereto and equivalents thereof.

What is claimed is:

1. A shield for a utensil that includes a handle comprising:
a shield body having a first opening formed therein, the first opening being open along a perimeter edge of the shield body;
a locking mechanism attached to a first face of the body and disposed about the first opening and being configured to grasp and hold the handle, thereby attaching the shield to the utensil, the locking mechanism including a clamp body that has a first section that is attached to the first face of the body and a pair of flexible fingers extending outwardly from the first section, each finger terminating in a coupling member that has first and second protrusions extending radially outward therefrom, the locking mechanism further including a pair of rotatable clamp arms that are rotatably coupled to the coupling members of the flexible fingers such that the clamps arms are in adjacent, parallel planes and are movable between an open position and a closed position, each clamp arm having an opening that receives a portion of the respective coupling member and a V-shaped body section, the clamp arm including a catch member that is configured to fasteningly mate with the first protrusion, thereby locking the clamp arm to the coupling member resulting in the clamp arms being locked in the closed position, the clamp arms being at least partially overlapped and in the open position, the clamp arms define a V-shaped slot for receiving the handle and in response to movement of the handle in a direction toward the first opening, the clamp arms rotate about the coupling members until the clamp arms assume the closed position in which the handle is captured between the V-shaped bodies of the clamp arms and the first protrusion is fasteningly mated with the catch member, thereby securely attaching the shield to the handle.

2. The shield of claim 1, wherein the fingers have an arcuate shape and each coupling member has a landing on which the clamp arm pivotally rests.

3. The shield of claim 2, wherein heights of the coupling members are different.

4. The shield of claim 1, wherein the first protrusion has a rounded end and the second protrusion has a first beveled side edge.

5. The shield of claim 4, wherein the catch member has a rounded slot that receives and frictionally holds the first protrusion therein, the catch member having a second beveled side edge, wherein in the open position, the first and second beveled edges seat flush against one another to limit rotation of the clamp arms.

6. The shield of claim 1, wherein the clamp arms rotate in opposite directions.

7. The shield of claim 1, wherein each V-shaped body is defined by a short pointed section and a long pointed section.

8. The shield of claim 7, wherein the short pointed sections of the clamp arms at least partially overlap in the closed position and in the open position, the short pointed sections overlap with the long pointed sections of the opposing clamp arm.

9. The shield of claim 1, wherein in the closed position, the handle is captured in a diamond shaped space defined by the V-shaped bodies of the first and second clamp arms.

10. The shield of claim 1, wherein the fingers flex outwardly as the clamp arms move from the open position to the closed position.

11. The shield of claim 1, wherein the locking mechanism is only attached to the shield body at the first section of the clamp body, with the clamp arms being free of attachment with the shield body.
